(19) United States
(12) Patent Application Publication
(10) Pub. No.: US 2015/0298025 A1
(43) Pub. Date: Oct. 22, 2015

(54) FOCUSED SAMPLE DELIVERY AND ELUENT SELECTION FOR CHROMATOGRAPHY

(71) Applicant: Munson Technology LLC, Ithaca, NY (US)

(72) Inventor: Gary SCHULTZ, Ithaca, NY (US)

(21) Appl. No.: 14/255,196

(22) Filed: Apr. 17, 2014

(51) Int. Cl. B01D 15/10; G01N 30/74; G01N 30/72

(52) U.S. Cl. CPC B01D 15/10; G01N 30/7233; G01N 30/74; G01N 2030/027

(57) ABSTRACT

The present invention is directed to a chromatography system which comprises a column extending between first and second ends and defining a passage containing a chromatographic sorbent for retaining and separating components of a sample. In one embodiment, there is an inlet fitting device proximate to the first end of the column to define a column inlet port, a sample conduit positioned to discharge a sample into the inlet fitting device, a mobile phase conduit separate from the sample conduit and positioned to discharge fluid into the inlet fitting device, a first fluid pump connected to the mobile phase conduit for conveying a mobile phase fluid into the mobile phase conduit, and a second fluid pump connected to the sample conduit for conveying a sample into the sample conduit. In another embodiment, there is a column inlet port proximate the first end of said column, an outlet fitting device proximate to the second end of the column defining a column outlet port, a first effluent conduit positioned to receive a material discharged from the outlet fitting device, and a second effluent conduit separate from the first conduit and positioned to receive material discharged from the outlet fitting device. A further embodiment of the present invention relates to a column inlet port proximate the first end of the column, a first frit proximate to the first end of the column, a second frit proximate to the second end of the column, where the first and second frits are positioned to retain the sorbent within the passage of the column, an outlet fitting device proximate to the second end of the column defining a column outlet port, and an effluent conduit positioned against the second frit to receive a material discharged from the outlet fitting device. Methods of analyzing with these systems are also disclosed.

### FIELD OF THE INVENTION

The present invention relates to focused sample delivery and eluent selection for chromatography.

### BACKGROUND OF THE INVENTION

Purification and separation of compound mixtures to isolate or detect components with high selectivity and sensitivity is desired. Chromatography is a method of fractionating component mixtures. Generally, in liquid chromatography, a sample containing a mixture of compounds is injected into a fluid stream which traverses the length of a chromatographic column containing a stationary phase. The fluid stream, otherwise known as the mobile phase, is generally formed when combining a weak mobile phase with a strong mobile phase. The two phases are combined using a chamber with two inlets and one outlet, often referred to as a mixer, or mixing chamber. The ratio of weak to strong mobile phase is varied to effect the separation and the component interaction between the stationary phase particles packed within the column and the mobile phase.

The high performance liquid chromatography system (HPLC) is thus comprised of a pump for mobile phase delivery at controllable flow rates and composition, a mixing chamber to uniformly blend a mobile phase delivered by two or more pumps, a sample injector to introduce sample volumes into the fluid stream, a column generally in a tubular shape containing a stationary phase consisting of a material or particles to effect retention and separation of the components, control of the mobile phase composition and component interaction with the stationary phase, and a detector to measure changes in the physical or chemical properties of the effluent over time. Generally a detector responds in proportion to the concentration changes as the separated component mixture passes into or through the detector.

There are several limitations and deficiencies in the design and implementation of HPLC columns and systems. Firstly, samples which are prepared for injection are generally required to be diluted into a solution which enables retention by the stationary phase when the fluid stream containing said injected sample first interacts with the stationary phase in the column. In HPLC systems, samples are injected or introduced into the fluid stream using an autosampler fitted with a needle or capillary tube to draw samples from a sample container into a valve through which the mobile phase passes or the injector needle becomes a component part of the fluid stream. The fluid stream containing the injected sample then travels through a length of tubing of small diameter at a high linear velocity until it reaches the inlet of a column containing stationary phase. Residue from injected samples, otherwise referred to as ‘carryover’, often contaminates the injector and tubing prior to the column inlet. Components in the sample often contaminate the sample injector, valves and tubes used to deliver the injected samples to the stationary phase in the column leading to carryover measured in sequential sample injections.

Carryover is one of the main limitations of most HPLC systems. Sample injectors and the tubing material chosen to connect the fluid stream between the injector and the column is often a place for sample carryover to take place. One approach to minimize carryover is to inject samples prepared in a strong solvent that can minimize the interaction of the injected sample with these surfaces prior to the column inlet. This limitation is addressed with some success by U.S. Pat. No. 7,875,175 to Wheat, et. al., whereby the injected sample is introduced firstly into the strong mobile phase and diluted into the weak mobile phase using a mixing chamber located near the entrance to the column. The limitation of this approach is the large increase in mobile phase volume needed to adequately dilute the sample to focus the sample on the column stationary phase.

Dispersion of solute bands within the stationary phase is mainly due to three mechanisms acting on a solute band as it moves through the stationary phase of the column. Eddy diffusion and flow dispersion describes the result of different flow paths taken by solutes. Lateral diffusion is the radial movement of solutes across the column. Longitudinal diffusion and mass transfer effects are due to sorption and desorption of the solute between the mobile and stationary phases. These dispersion mechanisms are well understood and, in sum, are used to calculate the height equivalent theoretical plate of a given column system. The Van Deemter plot is well known and describes the plate height of a column as the sum of the diffusion and dispersion mechanisms versus linear velocity of the mobile phase through the column from which the minimum plate height, H, can be determined.

Dispersion outside of the column results due to dead volumes in injectors, tubing connecting the injector to the column, column fittings, and tubing connecting the column to the detector. This type of dispersion is called extra-column dispersion and contributes to a loss in chromatographic resolution once the effluent exits the column stationary phase. Extra-column dispersion can be minimized by use of tubing with inner diameters that are small relative to the column diameter. Generally, the smallest tubing diameters are used and limited by the fluidic pressure generated when pumping high flow rates through small diameter tubing as the pressure increases in proportion to the square inner radius of the tube.

A limitation of HPLC columns is the design of the inlet and exit ports. These inlet and exit ports are designed to minimize the void volume of the column thus resulting in improved chromatographic performance characteristics. For sample and mobile phase delivery to a column inlet, the result of having a small diameter inlet port is that mobile phase and injected samples enter the column stationary phase at a linear velocity 10 to 500-fold higher than optimal to effect a separation due to the reduction in a surface area of the column inlet port relative to the cross-sectional area of the column stationary phase. Furthermore, particulates present in the mobile phase and injected samples are captured on a surface area of the inlet frit located immediately downstream from the inlet port causing the frit, positioned between the column inlet and the stationary phase, to occlude. The column backpressure increases due to flow restrictions and degrades chromatographic integrity and performance of the column.

Another limitation with column inlet frits and HPLC systems with this configuration is the linear velocity of the mobile phase flowing through the column inlet port. The mobile phase linear velocity entering the stationary phase immediately downstream from the inlet port and frit is much greater than what is optimal to effect a separation of the component mixture. The linear velocity radiates from a point source generally located at the center of the column but quickly spreads to the outer diameter of the column. Injected samples follow these flow vectors with the high velocity solvent until which time it diffuses through the mobile phase and sustains a sufficient interaction with the stationary phase to be retained by the stationary phase. The result is an undesired broadening or spreading of injected samples radially and longitudinally within the stationary phase immediately downstream from the inlet frit located at the column entrance.

Column exit fittings have exit ports, generally identical in size and shape to the inlet port, designed to minimize post-column volume, most typically having a port orifice of 20/1000″ (0.5 mm). Exit fittings are designed to press the column frit and column body together to retain the stationary phase. The downstream end of column fittings are designed to connect with narrow bore tubing, most typically using threaded fittings, with ferrules and nuts to make high pressure fluidic connections. Tubing diameters narrower than exit port orifices are possible using extruding processes to form tubes using materials such as metal, plastic and glass.

Generally, diffusion in the axial velocity varies in the radial direction according to the Hagen-Poiseuille equation. Consequently, the molecules on the center axis streamline will exit the column faster than molecules traveling on the streamlines away from the center axis. Molecules can also diffuse by molecular diffusion (Fick's law). Thus both axial and radial diffusion occur resulting in a distribution of residence times when molecules are transported between and along streamlines by diffusion according to the Aris-Taylor dispersion coefficient. The result of axial and radial diffusion is an analyte concentration gradient across the column radius with the highest concentrations located along the center axis of the column aligned with the column inlet while the lowest analyte concentrations located at the outer limits of the column inner diameter. The time difference between molecules which take a linear path versus a non-linear path through the column affects the temporal profile of the resultant chromatogram of each component. The severity of this chromatographic peak asymmetry is often a measure cited in HPLC column literature and is generally visible as chromatographic peak tailing on the trailing edge of a chromatogram.

The mobile phase high linear velocities and velocity gradients at the entrance and exit of HPLC columns negatively affects the separation and chromatographic resolution of the component mixture. In general, the inlet port and exit port of a column are aligned along the center axis of a cylindrical column. Due to the flow gradient, flow velocity vectors and diffusion within the mobile phase, a concentration distribution of analyte is established across the radius of a column with a higher concentration along the center axis aligned with the column inlet and exit, radiating out toward the width of the column. The radial expansion increases as the components migrate through the column toward the column exit.

The volumetric flow rate through a cylindrical column is proportional to the square of the column radius. For a column with a 4.6-mm diameter, the eluent flows through the column typically at 1.0 mL/min while for a column with a 1.0-mm diameter, the eluent flows at 0.047 mL/min. Given that an analyte concentration gradient is established across the diameter of a column with the highest concentration being aligned with the inlet port, preferentially sampling the center 1.0-mm diameter portion of the column effluent for detection contains more analyte molecules within a volume less than 20 times that of the 4.6-mm diameter resulting in a higher concentration detection sensitivity to be possible.

Multi-dimensional chromatography is generally performed by connecting two columns in series by placing a multi-port valve between the columns. Separating a component mixture using one column and selecting one or more components by fractionation and directed to a second column benefits from maximizing the concentration of the components of the first column while also minimizing the volume directed to the second column, as the diameter of the second column is generally one of smaller diameter resulting in enhanced detection sensitivity.

It is desirable to minimize the surface area and tubing that an injected sample must contact prior to interaction with the stationary phase of a column. It is desirable to prepare samples for injection onto a HPLC column in strong mobile phase or a solvent mixture optimal for analyte solubility and stability. It is desirable to minimize or eliminate high velocity flow gradients across the diameter and longitudinal length of a column. It is desirable to deliver the mobile phase across a surface area equivalent to surface area across the diameter of the column. It is desirable to selectively fractionate the effluent exiting the column containing the highest analyte concentrations to enhance detector sensitivity, sample fractionation and purification enrichment.

The present invention is directed to overcoming these and other deficiencies in the art.

### SUMMARY OF THE INVENTION

One aspect of the present invention relates to a chromatography system comprising a column extending between first and second ends and defining a passage containing a chromatographic sorbent for retaining and separating components of a sample. An inlet fitting device is proximate to the first end of the column defining a column inlet port, and a sample conduit is positioned to discharge a sample into the inlet fitting device. A mobile phase conduit separate from said sample conduit is positioned to discharge fluid into the inlet fitting device. A first fluid pump is connected to the mobile phase conduit for conveying a mobile phase fluid into the mobile phase conduit, and a second fluid pump is connected to the sample conduit for conveying a sample into the sample conduit.

Another aspect of the present invention relates to a chromatography system comprising a column extending between first and second ends and defining a passage containing a chromatographic sorbent for retaining and separating components of a sample. A column inlet port is proximate the first end of said column, and an outlet fitting device is proximate to the second end of the column defining a column outlet port. A first effluent conduit is positioned to receive a material discharged from the outlet fitting device, and a second effluent conduit separate from the first conduit is positioned to receive material discharged from the outlet fitting device.

Another embodiment of the present invention relates to a chromatography system comprising a column extending between first and second ends and defining a passage containing a chromatographic sorbent for retaining and separating components of a sample. A column inlet port is proximate the first end of the column. A first frit is proximate to the first end of the column, and a second frit is proximate to the second end of the column, where the first and second frits are positioned to retain the sorbent within the passage of the column. An outlet fitting device is proximate to the second end of the column defining a column outlet port, and an effluent conduit is positioned against the second frit to receive a material discharged from the outlet fitting device.

The present invention relates to a HPLC column design, a sample introduction method, and a mobile phase delivery method that minimizes or eliminates mobile phase velocity gradients at the column inlet and exit ports, minimizes or eliminates the concentrated flow of mobile phase and injected sample to a small fraction of the total surface area of the inlet and exit frits of a column, provides a means to introduce samples immediately adjacent to or within close proximity of the column inlet frit of a column, provides a means to sample a proportion of the effluent exiting the column containing the highest optimal concentration band which greatly enhances the chromatographic resolution, eliminates chromatographic peak asymmetry of prior art systems and increases detection concentration sensitivity over existing systems disclosed in the prior art.

According to one aspect of the present invention, a chromatography column is disclosed. The column comprises a chromatographic sorbent bed, a common inlet fluid connection port path upstream from the sorbent bed designed with a port diameter substantially equivalent in width to the sorbent bed and a column exit port downstream from the sorbent bed with a port diameter substantially equivalent in width to the sorbent bed. The column inlet port is in fluid communication with the common inlet fluid path and the column exit port is in fluid communication with the common outlet fluid path. The column inlet is designed to enable mobile phase eluent to flow across the column sorbent at fluid stream linear velocities optimal to effect a separation with the column. The exit port minimizes flow velocity variation at the column exit while enabling the fluid stream to be fractionated into two or more flow paths.

In another aspect of the present invention, a column inlet port is provided which enables a sample injection system to introduce a sample delivery device to deliver a sample volume at close proximity to the column sorbent. The column inlet port having an injection port for receiving said delivery device and a common inlet fluid path connected with a HPLC pump. The combined inlet port and inlet fluid path are designed to combine said sample volume and a weak mobile phase together using diffusional mixing at a linear flow velocity optimal for use with the column diameter and sorbent.

According to another aspect of the present invention, a column exit port is provided which is in fluid communication with a common outlet fluid path. The column outlet is designed to enable radial fractionation of the effluent into two or more fluid streams by incorporating a capillary tube with an entrance capillary substantially positioned along the sample injection axis. The column exit port optionally provides a means of enabling a fluidic connection between the column exit frit and extruded tubing used to transfer the effluent to a detector or other analytical device.

### BRIEF DESCRIPTION OF THE DRAWINGS

FIG. 1 is a cross-sectional view of a prior art chromatographic column with inlet and exit ports configured with a small diameter relative to the diameter of the column sorbent.

FIG. 2 is a cross-sectional view of a chromatographic column according to the present invention which provides enhanced chromatographic resolution by eliminating outlet port dead volume by enabling extruded tubing to be pressed against the column exit frit at the column exit.

FIG. 3 is a cross-sectional view of a chromatographic column according to the present invention which provides column dilution of a sample volume within a strong solvent injected into a weak mobile phase by optionally positioning the exit port of the sample delivery device upstream from the column inlet frit and radial fractionation of the effluent at the column exit.

FIGS. 4A-B show perspective views of the column inlet port and the column outlet port, respectively. FIG. 4A is a detailed drawing of a column inlet port coaxial to a sample delivery device in accordance with the present invention to provide column dilution and sample delivery to a column inlet which enables sample focusing on the stationary phase. FIG. 4B is a detailed drawing of a column exit port coaxial to an effluent fractionation capillary device in accordance with the present invention to provide radial fractionation of the effluent at the column exit for fluid delivery to a detector or second chromatographic column.

FIGS. 5A-C show a prior art column. FIG. 5A is a detailed illustration of a chromatographic column in accordance with the prior art in planar cross-section. FIG. 5B shows a cross-sectional view along Line B-B of FIG. 5A across the stationary phase immediately downstream of the inlet frit of the prior art. FIG. 5C shows a cross-sectional view along Line C-C of FIG. 5A across the stationary phase immediately upstream of the exit frit. FIGS. 5D-F show a column in accordance with the present invention. FIG. 5D is a detailed illustration of a chromatographic column in accordance with the present invention in planar cross-section. FIG. 5E shows a cross-sectional view along Line E-E of FIG. 5D across the stationary phase immediately downstream of the inlet frit of the prior art. FIG. 5F shows a cross-sectional view along Line F-F of FIG. 5D across the stationary phase immediately upstream of the exit frit. The shading is an illustration of the analyte concentration across the column diameter.

FIG. 6 illustrates two columns in series in accordance with the present invention to enable sample delivery to a second column of a radial fractionation of a first column.

### DETAILED DESCRIPTION OF THE INVENTION

One aspect of the present invention relates to a chromatography system comprising a column extending between first and second ends and defining a passage containing a chromatographic sorbent for retaining and separating components of a sample. An inlet fitting device is proximate to the first end of the column defining a column inlet port, and a sample conduit is positioned to discharge a sample into the inlet fitting device. A mobile phase conduit separate from said sample conduit is positioned to discharge fluid into the inlet fitting device. A first fluid pump is connected to the mobile phase conduit for conveying a mobile phase fluid into the mobile phase conduit, and a second fluid pump is connected to the sample conduit for conveying a sample into the sample conduit.

Another aspect of the present invention relates to a chromatography system comprising a column extending between first and second ends and defining a passage containing a chromatographic sorbent for retaining and separating components of a sample. A column inlet port is proximate the first end of said column, and an outlet fitting device is proximate to the second end of the column defining a column outlet port. A first effluent conduit is positioned to receive a material discharged from the outlet fitting device, and a second effluent conduit separate from the first conduit is positioned to receive material discharged from the outlet fitting device.

Another embodiment of the present invention relates to a chromatography system comprising a column extending between first and second ends and defining a passage containing a chromatographic sorbent for retaining and separating components of a sample. A column inlet port is proximate the first end of the column. A first frit is proximate to the first end of the column, and a second frit is proximate to the second end of the column, where the first and second frits are positioned to retain the sorbent within the passage of the column. An outlet fitting device is proximate to the second end of the column defining a column outlet port, and an effluent conduit is positioned against the second frit to receive a material discharged from the outlet fitting device.

The above-described systems can be used to carry out a method of analyzing a sample. In addition to providing one of the above-described systems, this method includes providing a sample and subjecting the sample to chromatographic analysis with one of the systems.

An illustrative embodiment of the present invention provides an enhanced chromatographic column and method for sample injection, separation, fractionation and detection. Those skilled in the art will appreciate that the present invention enhances sample focusing on a stationary phase of a column by injecting, loading, or delivering a sample to a stationary phase using a capillary tube or syringe separate from that used to deliver a mobile phase to a stationary phase. Independent sample and mobile phase delivery to a column inlet is accomplished by increasing the column inlet diameter to enable a sample delivery capillary tube to enter or be positioned substantially aligned with the center axis of a column while a mobile phase is delivered to the stationary phase coaxially to the sample delivery tube. A column inlet diameter equal to that of the stationary phase diameter enable the mobile phase to pass through the column inlet frit and sorbent bed at a linear velocity optimal to effect the chromatographic separation introduced equally across the column diameter, substantially eliminating the high linear velocities and radial expansion of the mobile phase and injected samples through column inlet ports taught by the prior art. The column inlet design of this invention enhances the chromatographic separation by elimination of the radial expansion of the mobile phase through the inlet port.

In one embodiment of the present invention, the sample delivery capillary tube or syringe is the same capillary tube or syringe used to transfer the sample volume from the sample plate using an autosampler. In this embodiment, the sample delivery tube or syringe enters the column inlet through a high pressure valve to inject a sample in the column inlet port and then exits the column inlet port. Carryover is minimized with this embodiment by reducing the surface area contacted by a sample volume compared to HPLC systems taught in the prior art. In another embodiment of the present invention, the sample delivery capillary tube or syringe is separate from that used in the autosampler.

Using a preferred embodiment of the present invention, the column inlet enables the ability to dilute samples dissolved in a strong solvent optimal for sample dissolution into a weak mobile phase at the column inlet. The sample injection is delivered to the column by diffusion into the mobile phase flowing at an optimal linear flow rate through the column inlet and entering the column inlet frit and column. Introducing samples into a fluid stream without radial velocity vectors provides for improved sample injection focusing of the sample on the center axis of the column stationary phase or sorbent bed.

In another aspect of the present invention, an exit port with a diameter close to or equal to the column diameter is disclosed. The exit port design of the present invention eliminates the flow vectoring and radial compression of the eluent in the sorbent bed prior to exiting the column exit port present in HPLC columns taught in the prior art. Positioning of a capillary tube within, against, or within close proximity to a column exit frit and substantially aligned with the center axis of the column or sample delivery tube enables radial fractionation of the effluent exiting the column. A capillary tube aligned with the center axis of the column can be used to preferentially fractionate or split the effluent exiting the stationary phase to transfer the middle portion of the column effluent to a detector, inlet of a second column, or to a fraction collection device, while the outer portion of the effluent passes to waste, an alternate device or detector. The volumetric flow rate of the middle and outer radial fractions is controlled by control of the volumetric split ratio and pressure drop across the two flow paths. With this invention, the middle fraction is directed to a detector, second column or alternate device such as a fractionation device. The exit port of the present invention enables the highest concentration analyte band located along the center axis of a column aligned with the sample injector to be selected for delivery to a detector or second column through use of a capillary tube concentric with the exit port and substantially aligned with the center axis of the sample injector. Meanwhile the effluent is passed at the outer radii of the column which contains an analyte at a lower concentration band to waste, alternate device or detector. The exit port with concentric capillary tubes enables radial fractionation by controlling the proportion of the effluent to be directed to a detector or second HPLC column.

The volumetric flow rate through a cylindrical HPLC column is proportional to the square of the column radius. For a column with a 4.6-mm diameter, the eluent flows through the column typically at 1.0 mL/min while for a column with a 1.0-mm diameter the eluent flows at 0.047 mL/min. Given that an analyte concentration gradient is established across the diameter of a column with the highest concentration being aligned with the inlet port, preferentially positioned on the center axis of the column, sampling the center 1.0-mm diameter portion of the column effluent of a 4.6-mm diameter column for detection contains more analyte molecules within a volume which is less than 20 times that of the 4.6-mm diameter. This results in higher concentration detection sensitivity. For example, if 1,000 analyte molecules were injected, separated and detected using a 4.6-mm column flowing at 1.0 mL/min with an analyte peak elution volume of 0.2 mL, then 1000 molecules divided by 0.1 mL results in a concentration of 10,000 molecules per mL. If 25% of the 1,000 analyte molecules were within a 1.0-mm diameter centered on the center axis of the 4.6-mm column, then 250 molecules would be detected in a peak elution volume 1/20^{th} of 0.1 mL resulting in a concentration of 50,000 molecules per mL. This results in a 5-fold increase in detection sensitivity with the disclosed invention compared with that available using a HPLC column and HPLC system of the prior art. Table 1 lists some further examples of the concentration factors from implementing radial fractionation relative to sampling the entire effluent as taught in the prior art.

TABLE 1

| | | Concentration | |
|---|---|---|---|
| Sampling | Percentage of | Relative to | Flow Rate Within |
| Diameter, | Analyte Within | 4.6 mm Sampling | Sampling Diameter, |
| mm | Sampling Diameter | Diameter | uL/min |
| 4.6 | 100 | 1 | 1000 |
| 1.0 | 10 | 2 | 47 |
| 1.0 | 20 | 4 | 47 |
| 1.0 | 30 | 6 | 47 |
| 1.0 | 40 | 8 | 47 |
| 0.5 | 10 | 8 | 12 |
| 0.5 | 20 | 17 | 12 |
| 0.5 | 30 | 25 | 12 |
| 0.5 | 40 | 34 | 12 |

Thus, radial fractionation enhances analyte detection by fractionating the most highly concentrated center radial fraction of the effluent of a column to a second column or detector.

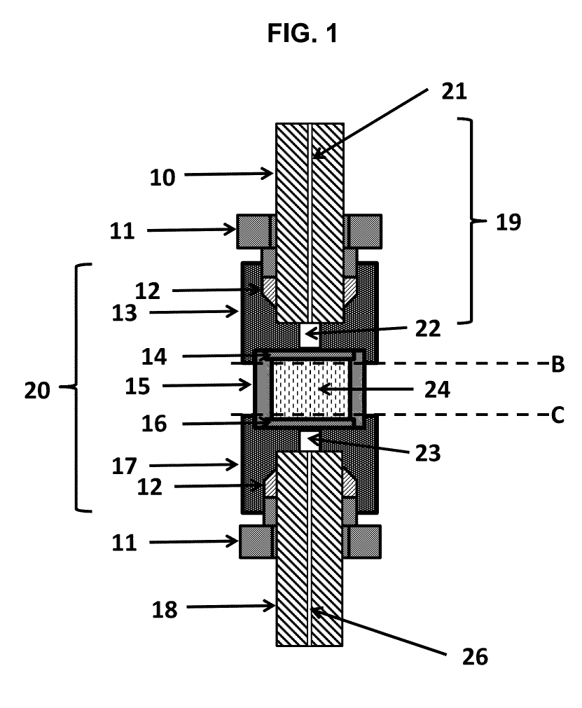

FIG. 1 is a cross-sectional view of a HPLC column of the prior art. HPLC column 20 consists of a cylindrical tube to serve as column body 15 containing stationary phase or sorbent bed 24, inlet frit 14 and exit frit 16 to retain the stationary phase within the column body. Inlet fitting 13 and exit fitting 17 typically threaded to the column body to retain the frits and stationary phase. Inlet fitting 13 contains threads to enable threaded nut 11 to connect tube 10 with inner diameter 21 to inlet fitting to form a seal using ferrule 12. The space between tube 10 and entrance frit 14 is called inlet port 22. The upstream end of tube 10 is connected to HPLC pumps and auto samplers in the prior art using a similar set of tube, nut and ferrule combination 19. Mobile phase, injected samples and eluent flow from the pumps and autosampler of an HPLC system through inner diameter 21 of tube 10 and flow through inlet port 22, inlet frit 14, and stationary phase 24 of column 20. Column exit fitting 17 is fitted with tube 18 with inner diameter 26, nut 11, and ferrule 12 using a threaded connection. Exit port 23 is a space between exit frit 16 and tube 18. The exit port of a prior art HPLC column is typically 20/1000″ (0.5 mm) diameter. Inner diameter 26 of tube 18 is designed to minimize the dead volume between the HPLC column exit port and a detector. When separating component mixtures, solute bands result for analytes based on their interaction with the mobile phase and stationary phase. Solute bands expand radially and axially as analytes migrate through the column toward column exit port 23. The portion of the solute band that remains on the center axis arrives at the exit port at a time ahead of the portion of the band located at the outer diameter of the column stationary phase due to dispersion and mobile phase flow gradients resulting from the prior art method of connecting columns with upstream HPLC pumps and autosamplers. The result of this band spread across the stationary phase is a temporal profile of the analyte exiting the column stationary phase at exit port 23 prior to entering inner diameter 26 of tube 18 connecting the column to a detector. The diameter and length of the exit port and its associated volume is a main cause of post-column band broadening of chromatographic bands which reduces the measured chromatographic resolution.

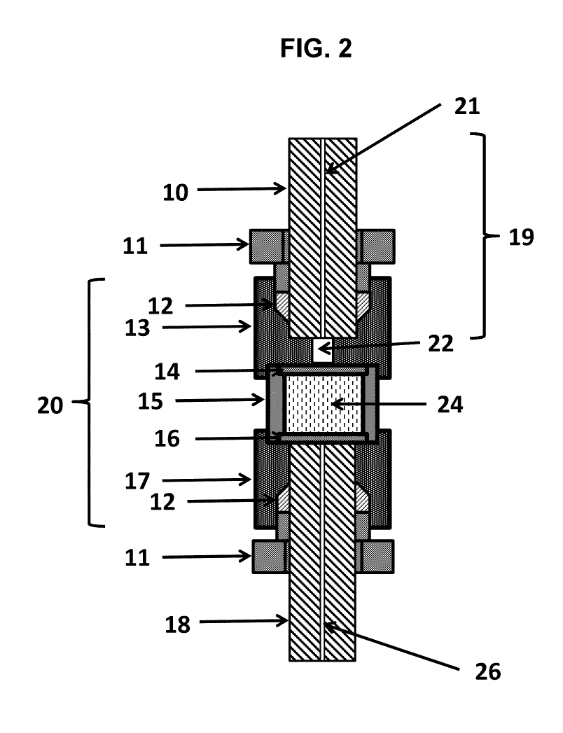

The present invention overcomes the limitation of post-column volume of exit ports 23 used in the prior art HPLC column as illustrated in FIG. 2 by elimination of the exit port by enabling connection tube 18 to be positioned against exit frit 16. FIG. 2 is a cross-sectional illustration of a HPLC column with inlet fitting 13 of the prior art and exit fitting 17 of the present invention. Elimination of the exit port enables the retention of the chromatographic resolution and separation performed on the stationary phase by transferring of the solute bands to a tube with a diameter much narrower than that possible with exit ports disclosed in the prior art. Elimination of the exit port enables extruded tubing to be used which can be of diameters as small as 1/1000″ (0.025 mm) thus preserving the separation quality and chromatographic resolution performed on the stationary phase. Extruded tubing is available in several types of metals, most typically used are various grades of stainless steel, plastic (such as PEEK), and glass, most typically fused-silica capillary tubing. In the case of fused-silica capillary, tubing inner diameters as small as 2/10,000″ (0.005 mm) are available.

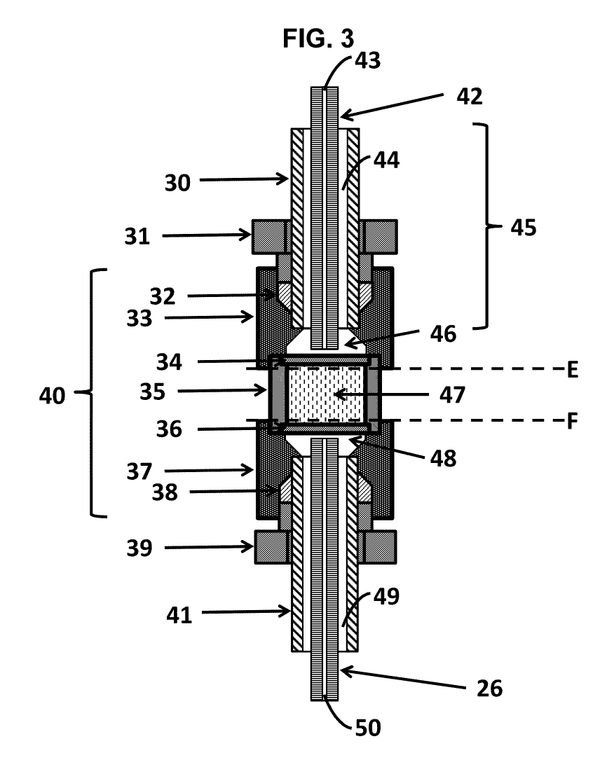

A preferred embodiment of the present invention can overcome the aforementioned limitations of the prior art HPLC column and system, as illustrated in FIG. 3. Carryover can be reduced by enabling capillary tube or syringe 42 with inner diameter 43 of an autosampler to inject or load a sample directly within inlet port 46 and positioned near, adjacent or within inlet frit 34 of an HPLC column. Column body 35, inlet frit 34, exit frit 36, and stationary phase 47 may be similar or identical to that of a HPLC column of the prior art. However, inlet fitting 33 has an inner diameter substantially equal to that of the column inner diameter adjacent to frit 34 to minimize or substantially eliminate the high velocity flow vectors of a mobile phase entering the column stationary phase. With this design, mobile phase enters the entire cross-sectional area of the stationary phase and column at a flow rate optimal to affect a chromatographic separation thus minimizing the radial flow vectors across the column diameter present with prior art column inlet port designs. The mobile phase is delivered to the inlet port of the present invention through space 44 defined by the gap between the inner diameter of tube 30 and the outer diameter of tube 42. Samples are delivered through inner diameter 43 of tube 42 to the inlet port of the present invention. The upstream end of tube 30 is connected to HPLC pumps. The upstream end of tube 42 is connected to a sample introduction device such as an autosampler. Tube 42 may be the syringe or capillary of an autosampler as previously described. Tube 42 may be used to enable samples dissolved in solvents optimal for sample dissolution to be combined with a weak mobile phase within the inlet port, inlet frit or stationary phase, depending on the position or placement of the downstream or exit end of tube 42. Tube 42 is preferably one formed using extruding methods such as those used to form stainless steel, plastic, or glass tubes. These tubes can have narrow inner diameters as previously disclosed which enable samples introduced to the stationary phase to focus on a much narrower initial diameter of the stationary phase than that possible with HPLC column fittings and inlet port designs of the prior art. Introducing the sample to the stationary phase using tube 42 also enables the flow rate used to deliver samples to the column to be controlled independently from that flow rate used to deliver the mobile phase to the column. Tube 30 is connected to column inlet fitting 33 using nut 31 and ferrule 32 or other means to form a high pressure seal capable of withstanding the high pressures of modern HPLC and UHPLC systems.

Column exit fitting 37 has a diameter substantially the diameter of the column stationary phase adjacent to exit frit 36. Tube 41 has an inner diameter of sufficient width to enable second tube or capillary 26 with inner diameter 50 to be positioned inside of tube 41 thus defining space 49 through which a portion of the effluent exiting the column to flow. The upstream end of tube 26 is positioned against, within or in close proximity to exit frit 36 so as to capture the central radial portion of the effluent exiting the column. Exit port 48 is optimally designed to minimize or eliminate flow velocity gradients of the effluent exiting the column stationary phase and exit frit. Tube 41 is sealed to column exit fitting 37 using nut 39, ferrule 38, or alternate devices to enable a high pressure seal.

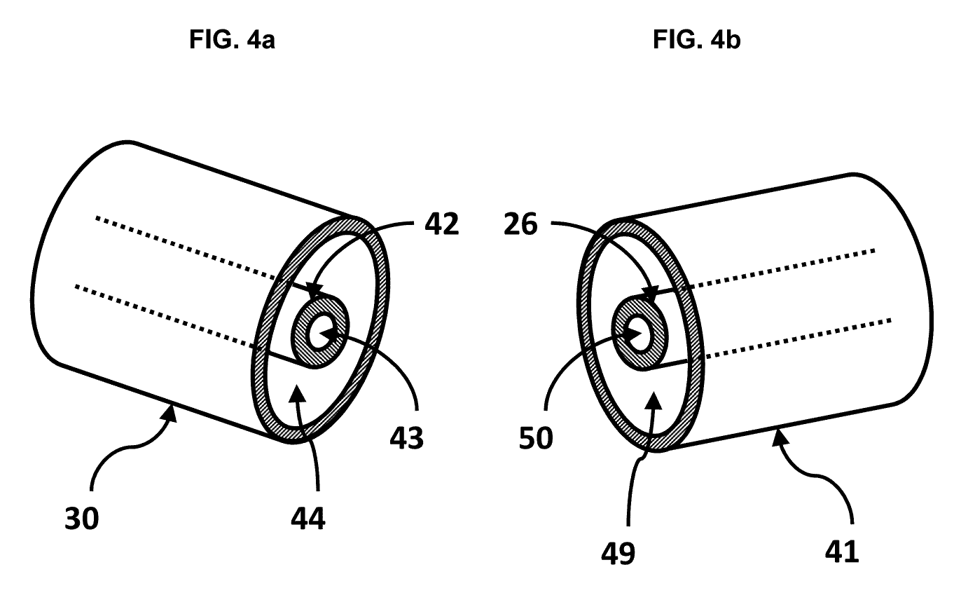

Concentric tubes 30 and 42 define space 44 through which mobile phase flows to inlet port 46 of a column of the present invention. FIG. 4A shows a detailed drawing of inlet tube 30, sample delivery capillary tube 42 with exit port 43 which is positioned against, within or near inlet frit 34 of the present invention. Concentric space 44 is defined between inner tube 42 and outer tube 30 which serves as a conduit through which the mobile phase is delivered to the column.

Concentric tubes 41 and 26 positioned in the exit port of a column of the present invention defines concentric space 49 used to accept a portion the effluent exiting the column exit frit are further illustrated in FIG. 4B. Concentric space 49 is defined between outer tube 26 and inner tube 41 with inner diameter 50 which serves as a conduit through which a portion of the effluent exiting the column flows. Inner diameter 50 of tube 26 serves to capture the center radial fraction of the effluent exiting the column. Space 49 between concentric tube 41 and tube 26 serves as a conduit through which the effluent not selected for detection or fractionation flows. The proportion of the effluent which flows through inner diameter 50 and space 49 is controlled by controlling the backpressure applied across the lengths of each flow path or conduit.

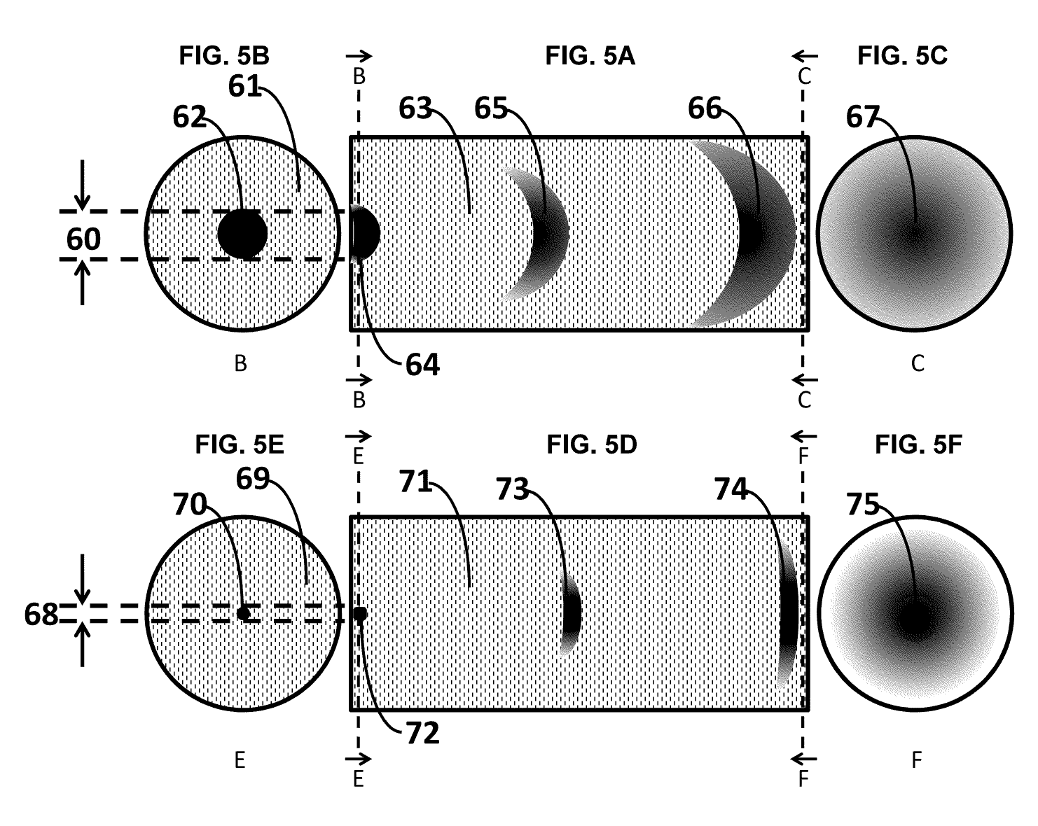

Three benefits of the column inlet design of the present invention are a reduction in carryover by minimizing the number of surfaces and surface area a sample volume contacts prior to reaching the stationary phase of the column, the elimination of the high linear velocity of the eluent entering the column inlet frit and stationary phase and the ability to independently load a sample using capillary 42 while delivering a mobile phase concentric to capillary 42 through space 44 defined by the outer diameter of tube 42 and inner diameter of tube 30. The separation of sample injection and mobile phase delivery to the HPLC column also results in two further benefits. Loading a sample volume using capillary tube or syringe 42 enables a reduction in the initial diameter of the analytes adsorbed onto the stationary phase. Delivering the mobile phase equally across the column inner diameter significantly reduces the flow vectoring of the mobile phase as it traverses the length of the column body thus minimizing the radial dispersion present with the column inlet designs taught in the prior art. This results in an initially smaller diameter analyte band 70 at the head or inlet end of column stationary phase 69 as illustrated in FIG. 5E. As the analyte partitions into an ever increasingly stronger mobile phase being delivered by the HPLC pumps, the analyte bands result in less radial dispersion, thus sustain a higher concentration of analyte within the center of the HPLC column stationary phase.

In a similar configuration, capillary tube 26 is positioned against, within or near exit frit 36 substantially aligned with the center of the HPLC column or aligned along the injection axis of capillary tube 42. The proportion of the effluent exiting the column which passes through tube 26 versus space 49 is controllable by design and dependent on the back pressures resulting from the choice of tube inner diameters and lengths for tube 41 and tube 26.

FIGS. 5A-F illustrate and compares the sample loading and chromatographic band broadening resulting from a column of the prior to that of the preferred embodiment of the present invention.

FIG. 5A shows the cross-section of a column found in the prior art. The end cross-sectional view in FIG. 5B illustrates the initial distribution of an injected sample which is retained on stationary phase 61 adjacent to inlet frit 14 of FIG. 1, while the cross-sectional view in FIG. 5C illustrates the analyte distribution of a separated sample immediately prior to elution from the stationary phase adjacent to exit frit 16 of FIG. 1. The shading in FIGS. 5A, 5B and 5C represent the density of analyte present across the column diameter as the analyte moves through the column during a chromatographic separation. Upon sample loading with a 20/1000″ inlet port 22 of the prior art using a 2.1-mm diameter column results in a high density loading of sample 62 shown in FIG. 5B with diameter 60. The mobile phase and injected sample flow through the inlet port at a linear velocity 20 times higher than the flow rate optimal to perform a separation with a 2.1-mm diameter column. This results in a rapid radial expansion of the analyte bands 64, 65, and 66 within stationary phase 63 as the analyte is separated through the column toward the column exit resulting in a broadly diffuse distribution of analyte 67 shown in FIG. 5C.

FIG. 5D shows the cross-section of a column of the preferred embodiment of the present invention. The cross-sectional view of FIG. 5E illustrates the initial distribution of injected sample 70 which is retained on stationary phase 69 adjacent to inlet frit 35 of FIG. 3. The cross-sectional view of FIG. 5F illustrates analyte distribution 75 within stationary phase 71 adjacent to exit frit 37 of FIG. 3. The shading in the column cross-section represents the density of analyte 72, 73, and 74 present at each column radius as the analyte moves through the column during a chromatographic separation. The inlet port of the preferred embodiment of the present invention is optimally designed to enable sample volumes to be loaded to the stationary phase at linear velocities optimal for focusing the sample with initial diameter 68 much smaller than that possible with prior art inlet ports. Additionally, the mobile phase is delivered across the width of the inlet frit and stationary phase at a linear flow rate optimal to affect a separation for the column. By design, the result is a narrower radial and axial distribution of analyte bands as analytes are separated during a chromatographic separation which results in a separation with higher resolution and concentration sensitivity than that available with prior art column designs. Capillary tube or syringe 42 of FIG. 3 and FIG. 4A can be of extruded materials such as stainless steel, plastic, glass, or fused-silica capillary thus enabling a higher density loading in a smaller initial diameter, as illustrated in the cross-sectional view of FIG. 5E, than that possible with the inlet ports taught in the prior art. The initial sample loading diameter 68 along with the independent delivery of a mobile phase to the column inlet from that used to deliver the sample further minimizes the radial dispersion of the analyte in the preferred embodiment of the present invention. The result of the improvements of the present invention is less band broadening both radially and axially and a narrower radial distribution of the analyte at the column exit, as shown in cross-sectional view FIG. 5D. The result, when implementing radial fractionation taught by this invention, is a significant improvement in chromatographic resolution, peak symmetry, concentration detection sensitivity, and fractionation of the analyte.

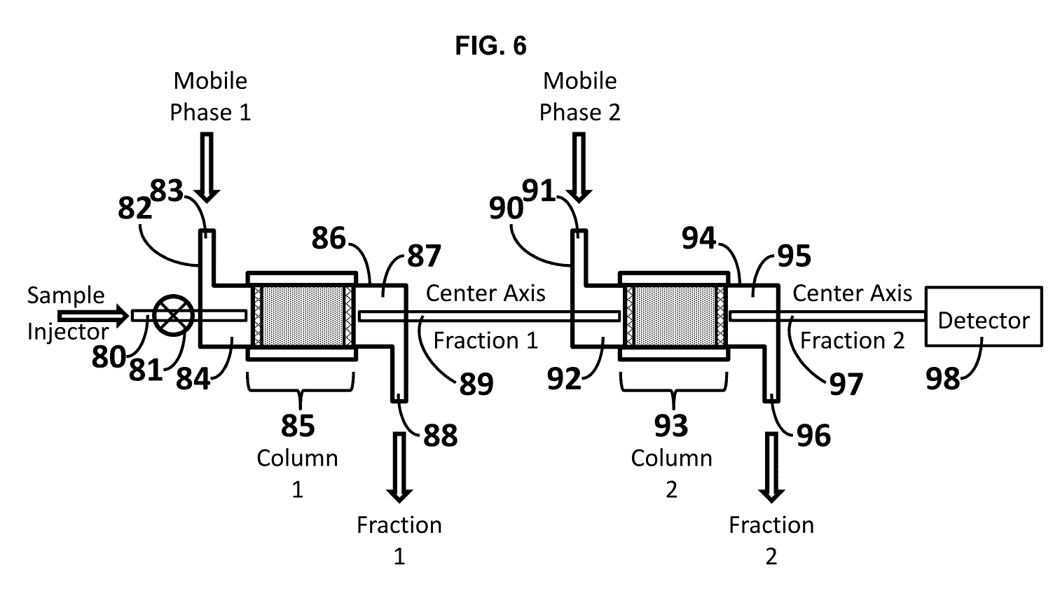

In a preferred embodiment, two columns of the present invention can be combined in series to enable multi-dimensional column chromatography using radial fractionation from a first column to a second column of the present invention, as illustrated in FIG. 6. A sample can be loaded through tube 80 which can optionally be inserted through valve 81 in fluid communication with inlet fitting 82 with inlet port 84. Mobile phase 1 is delivered through connection port 83 to the effect a separation in first column 85. Tube 89 is positioned within outlet port 87 of exit fitting 86 of column 1. The center radial fraction of the effluent exiting column 1 flows through tube 89 while the remaining effluent flows through outlet port 88. The portion of the effluent flowing through tube 89 exits the tube in inlet port 92 of second column 93. Inlet fitting 90 of column 2 has inlet port 92 through which mobile phase is delivered to the second column. Exit fitting 94 of column 2 defines exit port 95 in which second tube 97 is positioned along the center axis of column 2 through which the central radial fraction of the effluent flows to detector 98 while that portion of the effluent not selected for detection flows through outlet port 96 of the outlet fitting. As shown in FIG. 6, either or both of outlet ports 88 and 96 are connected to a fractionation device. Suitable detectors include an ultraviolet detector, a diode array detector, a fluorescence detector, a conductivity detector, an atmospheric pressure ionization source, an electrospray ionization source, or a mass spectrometer.

Although various embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A chromatography system comprising:
a column extending between first and second ends and defining a passage containing a chromatographic sorbent for retaining and separating components of a sample;
an inlet fitting device proximate to the first end of said column defining a column inlet port;
a sample conduit positioned to discharge a sample into said inlet fitting device;
a mobile phase conduit separate from said sample conduit and positioned to discharge fluid into said inlet fitting device;
a first fluid pump connected to said mobile phase conduit for conveying a mobile phase fluid into said mobile phase conduit; and
a second fluid pump connected to said sample conduit for conveying a sample into said sample conduit, wherein said sample conduit and said mobile phase conduit are in the form of extruded tubing of constant diameter and wherein the column inlet port has substantially the same width as the passage where said inlet fitting device and said column meet.

2. The system of claim 1, wherein said mobile phase conduit surrounds said sample conduit.

3. The system of claim 2, wherein said mobile phase conduit and said sample conduit are concentric.

4. (canceled)

5. The system of claim 1 further comprising:
a first frit proximate to the first end of said column and
a second frit proximate to the second end of said column, wherein said first and second frits are positioned to retain the sorbent within the passage of said column.

6. The system of claim 5, wherein said sample conduit is positioned against said first frit.

7. The system of claim 1, wherein said sample conduit is made from metal, plastic, glass, or fused silica.

8. The system of claim 1 further comprising:
an outlet fitting device proximate to the second end of said column defining a column outlet port;
a first effluent conduit positioned to receive a material from said outlet fitting device; and
a second effluent conduit separate from said first conduit and positioned to receive a material from said outlet fitting device, wherein said first effluent conduit and said second effluent conduit are in the form of extruded tubing and wherein the column outlet port has substantially the same width as the passage where said outlet fitting device and said column meet.

9. The system of claim 8, wherein said first effluent conduit surrounds said second effluent conduit.

10. The system of claim 9, wherein said first effluent conduit and said second effluent conduit are concentric.

11. (canceled)

12. The system of claim 8 further comprising:
a first frit proximate to the first end of said column and
a second frit proximate to the second end of said column, wherein said first and second frits are positioned to retain the sorbent within the passage of said column.

13. The system of claim 12, wherein said second conduit is positioned against said second frit.

14. The system of claim 1 further comprising:
an effluent conduit positioned proximate the second end of said column to permit material to be discharged from said column, wherein said effluent conduit is in the form of extruded tubing.

15. The system of claim 14 further comprising:
a first frit proximate to the first end of said column and
a second frit proximate to the second end of said column, wherein said first and second frits are positioned to retain the sorbent within the passage of said column.

16. The system of claim 15, wherein said effluent conduit is positioned against said second frit.

17. The system of claim 14 further comprising:
a detector positioned to receive material from said effluent conduit.

18. The system of claim 17, wherein said detector is selected from the group consisting of an ultraviolet detector, a diode array detector, a fluorescence detector, a conductivity detector, an atmospheric pressure ionization source of a mass spectrometer detector, an electrospray ionization source of a mass spectrometer detector, and a mass spectrometer.

19. The system of claim 14, wherein the system comprises a plurality of said columns in series.

20. The system of claim 14 further comprising:
a fractionation device positioned to receive material from said effluent conduit.

21. A chromatography system comprising:
a column extending between first and second ends and defining a passage containing a chromatographic sorbent for retaining and separating components of a sample;
a column inlet port proximate the first end of said column;
an outlet fitting device proximate to the second end of said column defining a column outlet port;
a first effluent conduit positioned to receive a material discharged from said outlet fitting device; and
a second effluent conduit separate from said first effluent conduit and positioned to receive material discharged from said outlet fitting device, wherein said first effluent conduit and said second effluent conduit are in the form of extruded tubing and wherein the column outlet port has substantially the same width as the passage where said column outlet sort and said column meet.

22. The system of claim 21, wherein said first effluent conduit surrounds said second effluent conduit.

23. The system of claim 22, wherein said first conduit and said second conduit are concentric.

24. (canceled)

25. The system of claim 21 further comprising:
a first frit proximate to the first end of said column and
a second frit proximate to the second end of said column, wherein said first and second frits are positioned to retain the sorbent within the passage of said column.

26. The system of claim 25, wherein said second conduit is positioned against said second frit.

27. The system of claim 21 further comprising:
a detector positioned to receive material from said first effluent conduit, said second effluent conduit, or said first and second effluent conduits.

28. The system of claim 27, wherein said detector is selected from the group consisting of an ultraviolet detector, a diode array detector, a fluorescence detector, a conductivity detector, an atmospheric pressure ionization source of a mass spectrometer detector, an electrospray ionization source of a mass spectrometer detector, and a mass spectrometer.

29. The system of claim 21, wherein the system comprises a plurality of said columns in series.

30. The system of claim 21 further comprising:
a fractionation device positioned to receive material from said first effluent conduit, said second effluent conduit, or said first and second effluent conduits.

31. A chromatography system comprising:
a column extending between first and second ends and defining a passage containing a chromatographic sorbent for retaining and separating components of a sample;
a column inlet port proximate the first end of said column;
a first frit proximate to the first end of said column;
a second frit proximate to the second end of the column, wherein said first and second frits are positioned to retain the sorbent within the passage of said column;
an outlet fitting device proximate to the second end of said column defining a column outlet port; and
an effluent conduit positioned against said second frit to receive a material discharged from said outlet fitting device, wherein said effluent conduit is an extruded tubing.

32. The system of claim 31 further comprising:
a detector positioned to receive material from said effluent conduit.

33. A method of analyzing a sample comprising:
providing said system of claim 1;
providing a sample; and
subjecting the sample to chromatographic analysis with said system.

34. A method of analyzing a sample comprising:
providing said system of claim 21;
providing a sample; and
subjecting the sample to chromatographic analysis with said system.

35. A method of analyzing a sample comprising:
providing said system of claim 31;
providing a sample; and
subjecting the sample to chromatographic analysis with said system.
